(19) United States
(12) Patent Application Publication
(10) Pub. No.: US 2018/0085747 A1
(43) Pub. Date: Mar. 29, 2018

(54) Tagging Of Small Containers For Biological And Chemical Samples With Light-Activated Microtransponders

(71) Applicants: Wlodek Mandecki, Princeton, NJ (US); Maryann Gruda, Yardley, PA (US); Ziye Qian, Monroe Township, NJ (US); Efrain Rodriguez, Bordentown, NJ (US)

(72) Inventors: Wlodek Mandecki, Princeton, NJ (US); Maryann Gruda, Yardley, PA (US); Ziye Qian, Monroe Township, NJ (US); Efrain Rodriguez, Bordentown, NJ (US)

(73) Assignee: PHARMASEQ INC., Monmouth JCT, NJ (US)

(21) Appl. No.: 13/239,779

(22) Filed: Sep. 22, 2011

Related U.S. Application Data
(60) Provisional application No. 61/386,179, filed on Sep. 24, 2010.

(51) Int. Cl. C12M 3/00; B29C 65/44; G06K 19/00; G06K 7/00

(52) U.S. Cl. CPC B01L 3/508; G08B 21/18; G01N 1/42

(57) ABSTRACT

Provided herewith, among other things, is an assembly comprising a test tube with an affixed very small, light-triggered transponder (“MTP”).

This application claims the priority of Ser. No. 61/386,179, filed Sep. 24, 2010, which is incorporated by reference herein.

Embodiments of the present invention generally relate to small biochemical containers and reaction vessels, such as test tubes and vials, with affixed light-activated microtransponders, and methods of making and using the same.

As described in U.S. Pat. No. 7,098,394, very small, light-triggered transponders are available to provide identifiers, for example as identifiers used in conjunction in nucleic acid assays. These have proven to be stable under a number of challenging conditions.

Radio frequency identification devices have been in use for some time, including for object tagging. Systems are available for example from Avid Technology, Inc. (Tewksbury, Mass.), Lutronic International (Rodange, Luxembourg) and Bio Medic Data Systems, Inc. (Seaford, Del.). In animal use, these systems are encapsulated, such as in biocompatible glass. Given the encapsulation, and the need for antennas, the smallest of these devices is believed to be just less than 0.84 mm by about 3 or 4 mm. As the transponder trigger is radio waves, typically there is no substantial issue with the orientation of the transponder once placed.

The most common method for tagging vials is barcoding. One-dimensional and two-dimensional barcodes may be printed and applied, or may be etched or molded into a specimen container. Barcodes suffer from the need to be visible (e.g., not hidden by frost), and can be damaged or removed by abrasion and chemical insults. In addition, some of the adhesives used on labels fail at low temperatures, especially if repeatedly exposed to cycling at extreme temperatures.

As an alternative to barcodes, applications of RFID technology have been developed for storage of biospecimens. Several manufacturers offer RFID technology as a part of print-and-apply label systems for biospecimen sample containers used at low temperatures. RURO (Frederick, Md.) and Zebra Technologies (Lincolnshire, Ill.) offer large adhesive label systems [1,2] where desktop readers and a special adhesive label containing an embedded RFID device are attached to the exterior of each sample container, while Maxell has announced and demonstrated in 2005 an RFID tag integrated with a container [3]. While both Maxell and Micronic [4] have indicated that the integrated product is being co-developed, there were no product listings as of a recent search. All of these systems require removal of the samples from the storage conditions in order to obtain sample identification. They are limited to large print-and-apply labels and/or specific container types (geometries).

There are other inconveniences or problems with the existing solutions. In most cases, the RFID tag or the barcode reside on the side of a vial on a label, rendering the readout of the barcode from beneath the rack impossible. Also, a concern is the integrity of the label under challenging conditions. And the cost of the label (excluding the vial) is substantial, around $1 per label for the RURO system. This number close to doubles the cost of storing a sample in a −80° C. freezer for a year, estimated at $1.00-$2.50 in large biorepositories.

Certain types of vials or test tubes are virtually impossible to tag with a typical label, barcode or RFID tag. One example is a popular REMP STBR384 vial, a “nanotube” [5]. These 40 μl polypropylene vials can be arrayed into custom 384-position racks (DTBR384). The very small vial (3.1 mm diameter and 19.1 mm length) is not addressable by any commercial labeling technology, but can be readily tagged with a MTP (defined below) chip as the dimensions of the tube and chip, and the thickness of the wall of the nanotube are compatible.

An ID system for tagging test tubes and vials is disclosed. The system in some embodiments includes a line of vials with MTPs embedded into plastic (e.g., polypropylene or acetal polymer) thus assuring absolute connectivity of the tag with the container. A useful location of the MTP is the center of the bottom of the vial, which permits a fast readout due to minimal manipulation required to position the vial and the embedded MTP over the laser beam of the reader. Additional identification means are possible, but not necessary. For instance, the MTP can coexist with a barcode, or a traditional RFID tag, which some users may prefer.

For manual reading of vials, a bench-top reader is described. Also described are readers for reading of racks of vials (e.g., 96 vials per rack). The rack reader can be used in a manual mode, or incorporated into an automated system. The reader for single vials resides on the benchtop and could be, for example, about the size of a computer mouse. Several exchangeable adapters (“form factors”) for different types of vials are developed to satisfy requirements of different biorepositories. In its basic implementation, the reader is connected to a computer via a USB 2.0 interface. The ID can be displayed on a small screen built into the reader.

The rack reader allows the readout of for example 96 vials in a few seconds. The same unit is capable of reading racks with fewer numbers of larger vials (e.g., 12, 24 or 48), where the same reader can be used where the position of centers of the larger containers coincides with those of the 96-vial form, enhancing the usefulness of the system. To read the ID, the user positions the rack over the reader and within seconds the ID is entered into a database and can be displayed on the computer screen.

The rack reader can be adapted to read MTPs associated with the rack, which can identify the rack, and can confirm or identify the orientation of the rack in the reader. For example, with a rectangular rack, a MTP can be in one corner, and its availability for reading can confirm that the rack is correctly aligned in the reader. Or MTPs can be in opposite corners, and the MTP aligned to be read will inform the reader of the rack ID and of the rack alignment.

Advantages of providing power to RFID tag by light versus RF. Conventional, passive RFID tags harvest power from the driving RF signal using antenna coils that are typically many centimeters in diameter. This results in up to approximately 1% efficiency of power transfer to the RFID device. In the case of those RFID methods that do NOT use such a large external antenna (such as the Hitachi mu-chip, now withdrawn from the market), the antenna efficiency drops by orders of magnitude, severely curtailing range and efficacy. Light energy harvested by photodiodes in the MTPs results in up to 10% efficiency in power transfer. Thus, because light-powered MTPs use energy more efficiently, they can achieve greater transmission ranges for the given small antenna size relative to pure RFID-based approaches. No other solution is smaller and more energy efficient.

Further, the method of powering each chip by a tightly focused laser beam allows specificity of physical addressing, i.e., addressing a dense array of tags in close proximity one tag at a time—an approach that is not feasible with conventional RFID methods. Using traditional RFID methods, multiple tags in close proximity will attempt to communicate simultaneously, mutually interfering with one another and preventing reading of the tags. This is known as “RFID tag collision”. An RF signal is only emitted from MTPs that are activated by the laser allowing precise positional specificity that can be applied to very small tube/plate systems such as the 384 well trays.

The MTP features enable a high level of security. While some RFID technologies enable additional information content, MTPs can contain only an ID number. All other information related to the sample container is stored in a secure database. Thus, nothing about the sample can be determined from the physical sample container itself. In addition, the benefits of the small form factor of the MTP antenna limits transmission range to less than 1 cm. Unintended transmissions are not likely.

### SUMMARY

Embodiments of the present invention generally relate to small biochemical containers and reaction vessels with affixed light-responsive transponders.

Provided, among other things, is a test tube and a vial with an fixed light-responsive transponder.

Provided among other things is an assembly comprising a test tube with an affixed MTP. The MTP can be embedded in the test tube, such as embedded underneath, oriented for reading downwards. The test tube can, for example, be a biorepository test tube. The MTP can, for example, be embedded in polypropylene or acetal polymer. The MTP can, for example, be embedded near the center bottom of the container.

Further provided is an MTP reader kit comprising an MTP reader with a vial receptacle and an insert for precisely fitting a given biorepository test tube in the vial receptacle. Still further provided is a multiplexing MTP reader adapted to systematically address 12 (24, 48, or 96) or more locations on a vial rack. For example, the 12 (24, 48, or 96) or more locations can be addressed by discrete lasers, and read with discrete pickup coils. Or, for example, the 12 (24, 48, or 96) or more locations can be addressed by discrete optical fibers driven by an optical multiplexer, and read with discrete pickup coils. Or, for example, the 12 (24, 48, or 96) or more locations can be addressed by robotically moving a wand. The reader or reader kit can comprise a mechanism for maintaining the biorepository test tube or vial rack at a temperature of −20° C. or less (−30° C. or less, 40° C. or less, −50° C. or less, −60° C. or less, −70° C. or less).

Also provided is a system for storing samples and comprising of the assembly discussed above and one or more of the following: a rack for biorepository test tubes; automated robot for moving racks or biorepository test tubes; and automated sampling device adapted to sample said racks or biorepository test tubes. The system can be adapted for low temperature operation, such that the racks/test tubes are handled at −20° C. or less (−30° C. or less, 40° C. or less, −50° C. or less, −60° C. or less, −70° C. or less).

Further provided is a method of embedding a MTP in plastic or comprising heating the MTP to above the melting point of the plastic and melting a portion of the plastic with the heated MTP. A method of reading an embedded MTP is provided comprising: providing an embedded MTP; and reading the MTP (which the embedding material can be frost coated). In the method, the vial receptacle and the embedded MTP can be maintained at a temperature of −20° C. or less (−30° C. or less, 40° C. or less, −50° C. or less, −60° C. or less, −70° C. or less).

Where this specification describes methods of reading the affixed MTPs or methods of affixing the MTPs, such methods are within the invention. Where this specification describes devices for reading the MTPs as affixed to the small biochemical containers and reaction vessels, such devices are within the invention.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only illustrative embodiments of this invention and are therefore not to be considered limiting of its scope, for the invention may admit to other equally effective embodiments.

The reading face of an exemplary MTP (defined below) is shown schematically in FIG. 1. The MTP has photocells 1, antenna 2, logic circuits 3, and memory circuits 4.

A wand device for reading an MTP is illustrated in FIG. 2, with a U.S. quarter superimposed for scale.

The electronic features of a wand device for reading an MTP are shown in FIG. 3.

FIG. 4 gives examples of test tubes in Panels A, B and C, and positions of MTPs on the bottoms. Panel D is a photograph of vial in Panel A showing the MTP.

FIG. 5 provides a cross-section of the bottom of a test tube showing the embedded MTP.

FIG. 6 schematically depicts a benchtop reader for individual containers tagged with MTPs.

FIG. 7 gives a cross-section of the benchtop reader of FIG. 4 showing the following internal components: 1: laser; 2: amplifier board; 3: digital boards; 4: receptacle for vials (form factor); 5: vial.

FIG. 8 depicts an alternative design (to that of FIGS. 6 and 7) of the benchtop ID reader for test tubes.

FIG. 9 gives a cross-section of the ID reader of FIG. 8. The major components are: 1: vial; 2: form factor; 3: laser; 4: digital board; 5: enclosure.

FIG. 10 presents a model of the ID reader for racks of vials. Panel A gives the overall view; and panel B—a cutaway. 1: Top cover; 2: vials; 3: rack; 4: housing; 5: lower pan; 6: power supply and regulation; 7: controller and USB interface; 8: laser array and control demultiplexer and 9: pickup coil array and multiplexer.

To facilitate understanding, identical reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

### DETAILED DESCRIPTION

### Description of Microtransponders

As described in U.S. Pat. No. 7,098,394, very small, light-triggered transponders (“MTPs” or “p-Chips”) are available to provide identifiers, for example as identifiers used in conjunction in nucleic acid assays (e.g., assays using DNA, RNA, or analogs thereof). These have proven to be stable under physiological conditions. Such devices have also provided a substrate on which new approaches for using metal particles have now been explored.

These MTPs are generally sided, in that the photocell/RF circuitry is formed on one face, and the other major face is generally bare, undifferentiated silicon—and can be a product of height reduction by back grinding. The circuitry face is generally protected by a passivation layer, such as of silicon dioxide, silicon nitride or mixtures, or multiple such layers.

A MTP has a length, width and height. A planar MTP is one where the height is 50% or less than the smallest of the length or width. In some embodiments, the height is 40% or less, 35% or less, 30% or less, 25% or less, or 20% or less, than the smallest of the length or width. MTPs used in the invention are often, but not necessarily, square or rectangular, consistent with a focus on low cost of production. A MTP is one where the longest of the length or width is 1.2 mm or less. In some embodiment, the longest of the length or width is 1.1 mm or less, 1.0 mm or less, 0.9 mm or less, 0.8 mm or less, 0.7 mm or less, or 0.6 mm or less. or 0.5 mm or less, or 0.4 mm or less, or 0.3 mm or less, or 0.25 mm or less, or 0.2 mm or less, or 0.15 mm or less. In one embodiment, the microchip is 600 micron×600 micron×100 or 120 micron.

Definition of test tube. A test tube, also known as a culture tube or sample tube, is a common piece of laboratory glassware or plasticware often consisting of a finger-like length of glass or clear plastic tubing, open at the top, usually with a rounded U-shaped bottom. A large test tube designed specifically for boiling liquids is called a boiling tube. Test tubes are available in a multitude of lengths and widths, such as from 10 to 20 mm wide and 50 to 200 mm long [9]. Some test tubes have a flat bottom; some are made so as to accept a stopper or cap.

Test tubes are usually held in special-purpose racks, clamps, or tongs. Some racks for culture tubes are designed to hold the tubes in a nearly horizontal position, so as to maximize the surface of the culture medium inside.

Test tubes for physics and chemistry are usually made of glass for better resistance to heat and corrosive chemicals and longer life. Tubes made from expansion-resistant glasses, such as borosilicate glass, can be placed directly over a Bunsen burner flame. Culture tubes for biology are usually made of clear plastic (such as polystyrene, polypropylene or acetal polymer) by injection molding [11] and are often discarded after use.

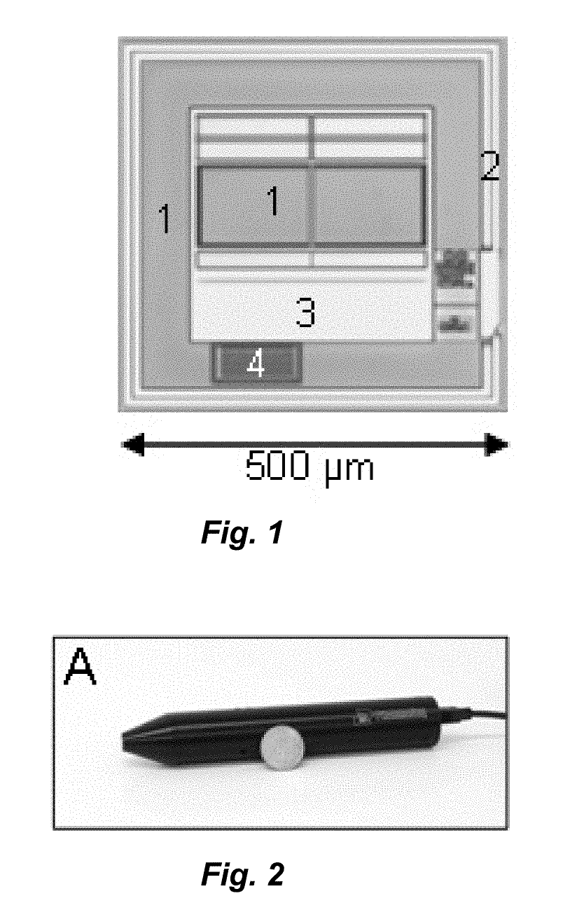

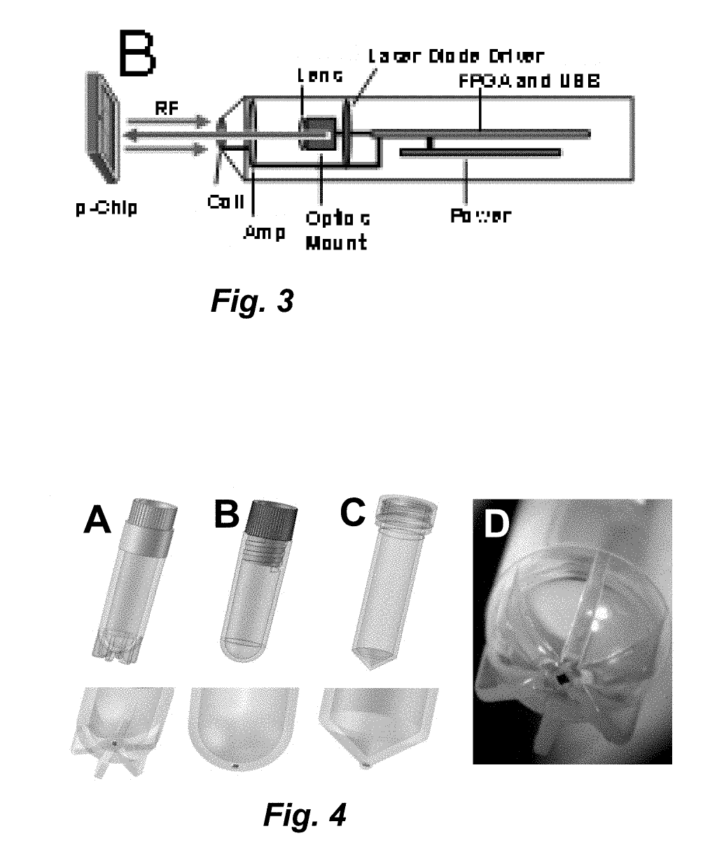

Examples of test tubes are provided in FIG. 4. Test tubes of smaller size, such as those illustrated, are often referred to as “vials.”

The invention can be used with test tubes traditionally used in tissue/cell/biomolecule storage, such as at biorepositories. Such test tubes are of relatively small capacity (to allow quick freezing) of 2.0 mL or less, such as 0.04 mL to 1.8 mL. They are typically plastic, often polypropylene. They typically have a screw-on or friction-fitted cap. They have a rounded conical interior bottom allowing the recovery with a pipette of small residual volumes. In certain embodiments, the MTPs are embedded in the structure underneath the rounded conical interior bottom of a tissue/cell storage test tube such that the structural integrity of the test tube is not compromised, and the MTP can be read from underneath the test tube.

### Methods for Affixing TPs to Test Tubes and Vials

Several methods can be used to place the chips onto test tubes and vials.

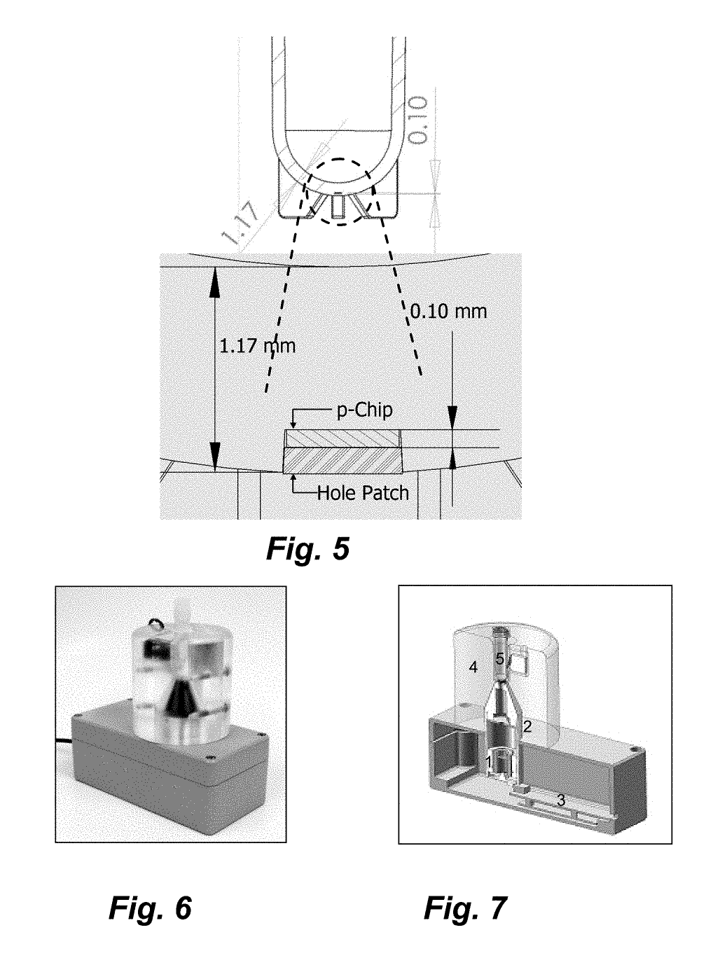

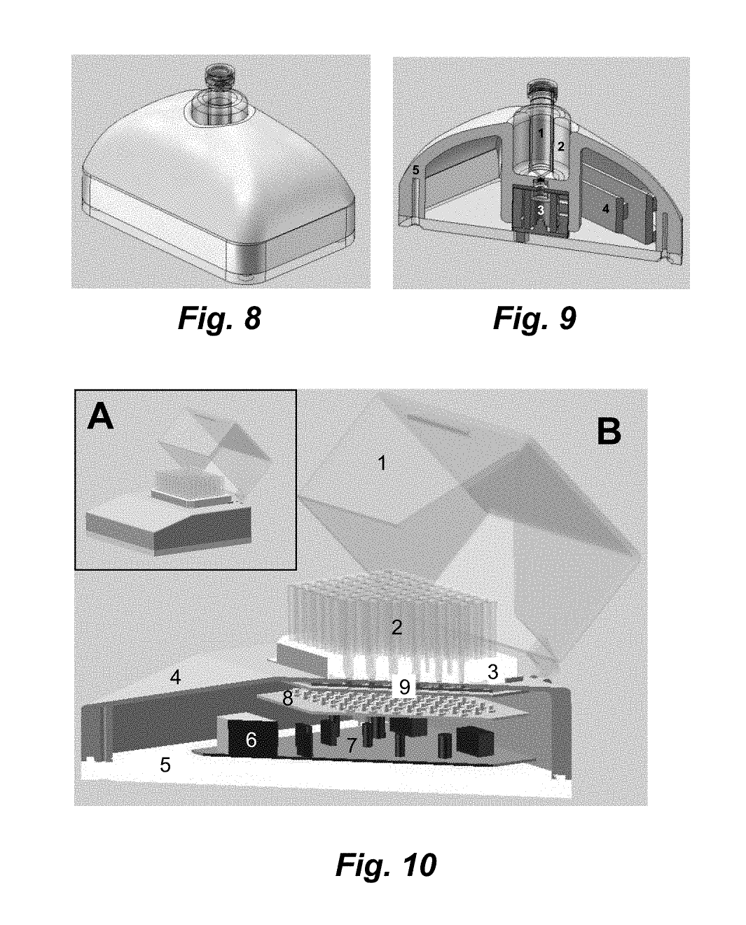

Thermal mounting of MTPs. A MTP is positioned in the center bottom of a test tube (e.g., a Nunc vial, Nalgene Nunc International, Rochester, N.Y.), then a modified soldering iron is placed on the face of the MTPs to heat it up to the temperature above the melting point for the plastic (e.g., polypropylene, about 160° C.); as a result the MTP sinks into the plastic. This step takes about 2 seconds. A soldering iron (model number WSD80 manufactured by Weller or similar) set to around 200° C. is used. After the MTP cools down to RT, either epoxy or molten, polymer (e.g., polypropylene) is used to seal the cavity. The placement of the chip in the vial is highlighted in FIG. 5. The wall thickness at the bottom of the vial is 1.17 mm, much greater than the thickness of the MTP (100 μm), so the embedding procedure does not significantly weaken the vial.

Sculpting of cavity for MTP. A guide specific to the vial type is made by stereolithography. The guide (which can have a metal insert to protect the plastic) is placed over the bottom of the vial, and a pointed soldering iron is used to melt a cavity of a selected depth in polypropylene. The depth can be defined by the guide. Then a MTP is manually placed into the cavity, which is then sealed with either epoxy or molten polymer (e.g., polypropylene). FIG. 5 depicts such cavity and a MTP residing in it.

Large-scale manufacturing. The principle for making MTP-vial assemblies will involve making a mold for injection molding the vials with a protrusion that corresponds to the recess to be occupied by the MTP, placing the MTP into the recess and sealing the cavity by ultrasonic welding, heat staking, or the like.

An important step in the post processing of the silicon wafers used to make the MTPs is the mechanical dicing in which the individual chips are cut. In order to do this, the thinned wafers are adhered to an adhesive film so that they remain in place while being diced. The chips can then remain on this film, either in sections or as a ribbon, permitting a straightforward alignment and embedding process where the chips are soldered into the test tube while still adhered to the thin film. Thermal soldering can be done with a stream of hot air. Alternatively, the MTPs can be placed on the cassettes with a pick-and-place robot and then thermally embedded.

The 40 μl REMP STBR384 vials (polypropylene, REMP AG, Oberdiessbach, Switzerland) can be arrayed into custom 384-position racks (DTBR384).

This very small vial (3.1 mm diameter and 19.1 mm length) is not addressable by any commercial labeling technology, but can be readily tagged with a MTP as the dimensions of the tube and chip, and the thickness of the wall of the nanotube, are compatible.

The illustrative ID reader (wand) of FIG. 2 is a hand-held device that can connect to a standard PC and capable of reading the serial number (ID) of individual MTPs. The wand can be, for example, USB-powered and contain a USB 2.0 transceiver microcontroller, a field programmable gate array (FPGA), power converters and regulators, a laser diode with programmable current driver, an optical collimation/focusing module, and a tuned air coil pickup with a high gain, low noise differential RF receiver with hysteretic comparator data slicer. The FPGA code in the ID reader can be upgraded to support incorporation of new features and performance enhancements. The wand contains a laser, for example emitting an average of 60 mW of optical power at 658 nm while reading. The ID is read when the MTP is placed within suitable proximity of the laser light. The light can be, for example, pulsed at 1 MHz; this feature can provide the data clock used by the MTP for synchronization of the transmitted ID data bits. The timing of the pulse groups can be set so that the duty cycles and average power levels fall within requirements for registration as a Class 3R laser device. For example, when in standby, the average optical power emitted is under 5 mW.

The resulting ID readout from the MTP can be rapid (less than 0.01 sec) and can be reported on the PC using application-specific software. One performance parameter of the wand is its read volume; i.e., the three dimensional space beyond its tip in which the ID can be read. This volume is a function of several variables, including illumination angle, illuminance energy, attenuation factors and tuning of the optical system's focal point. For example, the volume can be approximately 6 mm³ (4 mm×1.5 mm×1 mm).

Conventional, passive RFID tags harvest power from the driving RF signal using antenna coils that are typically many centimeters in diameter, depending on frequency of operation. This setup results in up to approximately 1% efficiency of power transfer to the RFID device due to propagation losses despite operating in the near field. In the case of those RFID methods that do not use such a large external antenna (such as the Hitachi mu-chip, now withdrawn from the market), the antenna efficiency drops by orders of magnitude, severely curtailing range and efficacy. Light energy harvested by photodiodes in the MTPs results in up to 10% efficiency in power transfer. Thus, because light-powered MTPs use energy more efficiently, they can achieve greater transmission ranges for the given electrically small antenna size relative to pure RFID-based approaches. No other remote tagging solution is physically smaller or more energy efficient.

Further, the method of powering each MTP by a tightly focused laser beam allows specificity of physical addressing; i.e., addressing a dense array of tags in close proximity one tag at a time—an approach that is not feasible with conventional RFID methods. Using traditional RFID methods, multiple tags in close proximity will attempt to communicate simultaneously, mutually interfering with one another and preventing reading of the tags. This phenomenon is known as “RFID tag collision.” An RF signal is only emitted from MTPs that are activated by the tightly focused laser allowing precise positional specificity that can be applied to very small tube/plate systems such as the 384 well trays.

MTP features enable a high level of security. While some RFID technologies enable additional information content, MTPs are conveniently made to contain only an ID number. All other information related to the sample container can be stored in a secure database. Thus, nothing about the sample can be determined from the physical sample container itself. In addition, the benefits of the small form factor of the MTP antenna limits transmission range to less than 1 cm, so that unintended transmissions are not likely.

### Readout of IDs of MTP-Tagged Test Tubes and Vials

Readout of MTPs Kept at −78° C. (dry ice). It is widely accepted that temperature fluctuations are detrimental to the long term stability of biospecimens. Thus, having a tag that functions on samples while they are still frozen is advantageous. To find out if MTPs can be read while at an ultra-low temperature, 26 MTPs were placed on dry ice (−78° C.) and the RF signal emitted by chips evaluated. The ID reader itself was kept at RT. All of the chips could be read although the time required to read the chips was increased slightly. The reader initially needed to be recalibrated to adjust for a shift in the amplitude of the RF signal emitted from the frozen chips as compared to room temperature chips. Further optimization of the reader settings can be expected to further shorten read times.

### ID Readers for MTPs Embedded in Test Tubes and Vials

Hand-held reader for single test tubes. The ID reader (wand) is a hand-held device connected to a standard PC and capable of reading the serial number (ID) of individual MTPs (FIG. 2). The wand is USB-powered and contains a USB 2.0 transceiver microcontroller, a field programmable gate array (FPGA), power converters and regulators, a laser diode with programmable current driver, an optical collimation/focusing module, and a tuned air coil pickup with a high gain, low noise differential RF receiver with hysteretic comparator data slicer.

The FPGA code in the ID reader can be upgraded to support incorporation of new features and performance enhancements. The wand contains a laser, for example emitting an average of 60 mW of optical power at 658 nm while reading. The ID is read when the MTP is placed within suitable proximity of the laser light. The light can be pulsed at 1 MHz; this provides the data clock used by the MTP for synchronization of the transmitted ID data bits. The timing of the pulse groups are set so that the duty cycles and average power levels fall within requirements for registration as a Class 3R laser device.

The resulting ID readout from the MTP is rapid (less than 0.01 sec) and is reported on the PC using application-specific software. We have shown that the wand will read MTPs under challenging conditions such as: through a sheet of white paper, blue-colored glass (˜1 mm thick), and a sheet of transparent plastic laminate. These conditions indicate a tolerance for other challenging conditions, such as frost. The key performance parameter of the wand is its read volume; i.e., the space beyond its tip in which the ID can be read. This volume is a function of several variables, including illumination angle, illuminance energy, attenuation factors and tuning of the optical system's focal point. Typically, it is approximately 6 mm³ (4 mm×1.5 mm×1mm).

Bench-top vial reader and its performance. This example of a bench-top ID reader is designed for vials having MTPs embedded in the center bottom of the vial.

Mechanical design. The reader is composed of the active reader electronics, optics, lower housing, upper housing and vial receptacle assembly including the appropriate form factor. The lower housing is shaped to accept the circuit elements of the reader electronics, provides a USB interface to the host PC through an opening in the housing and firmly anchors the PCBs. The upper housing supports the vial reader laser/optical module along with the pickup coil and analog signal preamplifier, all mounted in a custom-cut forward section of an ID reader wand that is mounted vertically, illuminating the vial receptacle for reading the MTP mounted on the base of the vial.

Electrical design. The clock signal from the laser can provide the carrier frequency used for emission of the serial ID number, therefore, the ID reader needs to house a laser power source. To recover the alternating magnetic field emissions from the MTP, a suitable coil that is made resonant at the operating frequency is used so as to maximize recovered signal voltage and reject out-of-band emissions. A low-noise differential amplifier provides gain with a high degree of common-mode rejection in order to preserve signal-to-noise ratio; the signal then proceeds to a voltage comparator. The binary sliced signal is then applied to a parallel processing decode engine realized in a field programmable gate array (FPGA). The decoder applies pattern-matching and other algorithms to recognize elements of the incoming bitstream so as to extract the serial ID value. These signal tokens are then passed along to the host PC, such as via a USB interface, for capture and presentation to the user. A safety switch/toggle can be added to inhibit laser operation in the absence of a vial.

Additional hardware enhancements. The sensitivity of the wand to read the ID of MTPs embedded in vials can be enhanced. Frost and ice can scatter laser light making MTP activation more difficult—though surprisingly good performance was obtained without enhancement. Signal averaging (in the current design, single frames of the ID [512 μs] are interpreted) can provide enhancement. Circuitry for analog-to-digital conversion, electronic memory and software for decoding the signal can be selected as appropriate for signal averaging. A digital signal processor (which can complement the improved analog preamplifier) based on the Altera Cyclone EP1C20 FPGA family can be introduced to the digital board. Further, to maximize probability of successful signal decoding, a multibit analog-to-digital converter can be used to digitize the signal emanating from the MTP allowing the use of linear pattern matching, digital filtering, and other means to decipher signal patterns from noise with increased resolution.

### Reader for Racks of Vials

The reader is an automated device that can read arrays of vial-embedded MTPs, such as to 96 vials per array.

Design. The reader can have the ability to accommodate, for example, a 96 vial array. The most challenging aspect of handling the number of locations lies in the ability to apply laser stimulation with sufficient intensity and with adequate coverage to ensure reading of the embedded MTP. We have shown that MTPs can be read through one such storage box. Three methods can be used: direct drive by discrete lasers, fiber-optic multiplexing and fully autonomous optical scanning.

Direct drive by discrete lasers. FIG. 10 depicts a design for accommodating an array of MTPs for the purpose of reading, i.e., as affixed to the bottoms of vials in an array. In this example, an array of 96 lasers is switched sequentially by a multiplexed laser driver controlled from FPGA logic. The pickup coil corresponding to the location being activated is also selected by a differential signal multiplexer. In this way, a single preamplifier and a single laser driver together service 96 vials. For ease of signal processing the lasers in this embodiment and others may be individually activated—but addition of multichannel processers can allow all or a useful subset to be processed in parallel.

Fiber-optic multiplexing. In this example, an array of optical fibers is switched sequentially by an appropriate optical multiplexer under control of the FPGA. The optical multiplexer replaces the switched laser array shown in the diagram (FIG. 10). A single laser provides the drive to stimulate a MTP situated on a vial at the addressed location. The pickup coil corresponding to activated location is also selected by a differential signal multiplexer for conveying the retrieved MTP emissions back to the signal decoder, as in the direct drive method described above. In this way, a single preamplifier and a single laser together accommodate 96 MTPs via the fiber-optic multiplexer.

Both of the above approaches are to be made ‘smart’ so as to enhance utility and safety. For example, each well can be adapted to detect the presence of an inserted vial, for example by a photo-interrupter arrangement, wherein an infrared beam shining across the well diameter is detected by a phototransistor, by a mechanical switch, Hall effect sensor, or the like. Occupied locations are mapped into the scanning repertoire, and unoccupied locations are excluded from the scan map. In this way, a randomly dispersed array of vials can be read rapidly and efficiently, without wasting laser dwell time on locations that are devoid of vials with MTPS. As an added benefit, spurious laser emissions are inhibited from radiating from empty wells. As an additional layer of safety, an optically opaque cover can be provided to ensure that no incidental laser emissions could escape. To be flexible enough to accommodate the variety of vials available in the marketplace, this reader can have exchangeable form factors for different sizes of vials, each being adaptable to similar types in that size range.

Scanning. Incremental positional scanning is one method for examining the contents of each element of an array in sequential fashion. The method can use a single reading station to interrogate each element in repertory sequential fashion, the array structure itself being moved incrementally by external robotic action (low cost gantry-type system or similar). This method enjoys advantages, including the ability to keep the vials in an enclosed box, avoiding warming by exposure to ambient air. This also eliminates the high cost of arrays of lasers or fiber optic plumbing.

In all of these methods and devices for multiplex reading, form factors can be to increase the reading capacity of the device. For example, a 96 vial reader can be adapted to position the vials of a 384 vial tray in four separate orientations so as to address all 384 vials.

Cooling options. For any of the above designs, the rack reader can be cooled with a Peltier device (or other cooling process) to prevent samples from warming up while the IDs are being read. Cooling is currently deemed unnecessary as the time needed to read the vial is very short as it is removed as soon as it reaches the bottom of the form factor within the reader. Explicit cooling can be implemented if needed. Other cooling methods include for example, using adjacent pathways for heat exchange fluids (selected for the appropriateness with the desired temperature) which are refrigerated or heat exchanged with cold fluids such as solvent/CO₂, liquid nitrogen, liquid helium, or the like.

### Ruggedization of ID Readers for Performance at Low Temperature

The electronics used can be extended-temperature grade devices since commercial types are generally only specified for 0 to 70° C. operation. Military grade devices can extend operation down to −55° C. or lower. Laser output increases in cold conditions, increasing MTP emission strength. And preamplifier noise decreases, increasing sensitivity. Overall, performance is expected to improve somewhat given that any heat generated in the reader will rapidly be dissipated. Capacitors designed for extended low temperature operation will be selected as commonly used dielectric characteristics for commercial capacitors cause these devices to wildly change capacitance values with temperature changes. Useful dielectric types include NPO and COG.

Testing was performed to assess the stability of MTPs after storage at −80° C. MTPs were embedded into a sheet of polypropylene using the method described below. 100 MTPs were then placed in a −80° C. freezer. Each day, over a period of three weeks, the chips were removed from the freezer and tested at room temperature (RT) for ID read functionality, after which the chips were returned to the freezer. One hundred percent of the MTPs were able to be read every day.

Conclusion: Storage of MTPs at −80° C. and temperature cycling from −80° C. to RT does not adversely affect their performance.

MTPs were applied to polypropylene sheets of differing thicknesses. The chips were oriented in two ways: facing toward the polypropylene for emulation of optical transmissive degradation, and upward facing for frost accumulation testing. The softening temperature point of polypropylene is about 160° C., so a soldering iron (model number: WSD80 manufactured by Weller) was used with the temperature set at around 200 ° C. 119 MTPs were thermally embedded facing up into a 1.56 mm thick polypropylene sheet. 23 MTPs were thermally embedded facing down onto another polypropylene sheet of the same thickness. All MTPs residing on the polypropylene sheets were coated with fast-setting epoxy. For testing, both polypropylene sheets were removed from the −80° C. freezer daily and all MTPs were successfully read by the wand. After each reading, both polypropylene sheets were returned to the freezer.

In addition, we were able to read all of the tested MTPs (n=6) through the plastic bottom of the commonly-used, polypropylene freezer storage box (Denville Scientific, Metuchen, N.J.). The thickness of the polypropylene was 2.05 mm.

Conclusions: (1) A method to embed MTPs in polypropylene sheets was demonstrated. (2) MTPs can be read through 2.0 mm thick sheets of polypropylene. (3) MTPs can be read through translucent storage boxes.

### 3.1.4 Embedding MTPs into Vials

To determine feasibility of mounting MTPs onto vials, three types of commercial cryovials were used: Type 1 (CryoTube by Nunc), Type 2 (Cat. #V9013 by Denville Scientific), and Type 3, a generic screwcap conical microcentrifuge tube from Fisher Scientific (FIG. 3). The MTP was positioned at the center bottom of each vial and covered with an epoxy adhesive. For Type 1, MTPs were directly glued to the bottom center, surrounded by the six fins on the bottom of this type of vial (FIG. 3), which should prevent damage to the MTP during handling. For Types 2 and 3, the center bottoms first were ground with a sanding disc and the MTPs affixed to the surfaces with epoxy adhesive. After curing, a second coat permanently sealed the assembly. Conclusion: Feasibility of mounting MTPs on vials was demonstrated.

This test was aimed at determining the viability of embedded MTPs over repeated cycling of temperature extremes. The three types of vials (two specimen each) embedded with MTPs, as described above, were subjected to a temperature cycling between RT and −80° C. After each withdrawal from the freezer, the chips were read. This was repeated 25 times over a 5 week span. All ID readouts were successful. Conclusion: Repeated temperature cycling (RT to −80° C.) does not damage MTPs embedded in the vials.

The RF transmission functions of MTPs were tested after incubation at a temperature significantly higher than the melting point of polypropylene (about 160° C.). A high-temperature oven and loose MTPs in a glass container were used. The experiment showed that MTPs have excellent temperature stability: they can be incubated at up to 520° C. for 8 h and still have full RF activity (sample size: 100 MTPs, all of which were fully functional at the end of incubation). In additional experiments, MTPs (sample size of 100) are not affected by:

(a) centrifugation (15 min in a microcentrifuge at about 15,000 g),

(b) exposure to strong near-field microwave radiation (1 hour exposure, standard 700 W microwave oven),

(c) autoclaving dry or in water (a total of 15 repeats of the complete autoclave cycle were tested), which is of significance as the MTP-tagged vials will be able to be used in many common laboratory procedures.

(d) incubation in solvents (for 15 days), such as: DMF, DMSO, methanol, ethanol, H2O, pyridine, DCM, chloroform, acetonitrile, and toluene; 80-100% of the chips maintained their RF performance.

Conclusions: (1) MTP retain function after incubation at temperatures much higher than the melting point of polypropylene. (2) Many common laboratory procedures and solvents will not adversely affect the performance of MTPs.

Frost covering the face of a MTP can impede illumination of the photocells, potentially impairing operation of the MTP by reducing net optical power delivery to the chip thus reducing RF radiation. An effort was undertaken to determine extent of impairment on reading posed by the presence of frost on the vial's active surface.

A regular microscope slide was chilled to −80° C. in the freezer. While in the open freezer compartment, the slide was exposed to a stream of 37° C. air with 100% humidity. We let the frost form over a period of 15 sec. While the slide was still in the freezer, we qualitatively compared light scattering on the glass slide to scattering from seven custom made standards. We observed that scattering by frost was equivalent to that of a standard having 40% transmission efficiency (as measured on Varian Cary 50 UV-Vis spectrophotometer). This standard was then used to determine the readability of MTPs through the standard at RT at a distance of approximately 1 mm from the chip. We found that IDs of all ten chips tested could be read. A reduction of the reading range was noted. The simulated (by the scattering standard) level of frost is sufficiently thick to prevent recognition of a 2D barcode printed on the bottom of a 2 ml Micronic tube.

Filed concurrently herewith, and incorporated by reference for all methodologies applicable to the currently claimed invention, is an Application entitled “Tagging of Tissue Carriers with Light-Activated Microtransponders,” Atty. Dkt. No. PHSQ004P, Ser. No. 61/386,188, filed Sep. 24, 2010.

### BIBLIOGRAPHY

1. http://www.ruro.com/products/freezerpro/custom.html

2. http://www.zebra.com/id/zebra/na/en/index/industry_solutions

/technologies/rfid_printing_encoding.html

3. http://www.maxell-usa.com/index.aspx?id=4;41;434;0

4. http://www.micronic.com/NewsDetails.aspx?NewsItem=27

5. REMP specification sheet ©2005 by REMP AG/350 014-USV1.0, 01-2007

6. Mandecki W, Ardelt B, Coradetti T, Davidowitz H, Flint J, Huang Z, Kopacka W, Lin X, Wang Z, and Darzynkiewicz Z. 2006. Microtransponders, the miniature RFID electronic chips, as platforms for cell growth in cytotoxicity assays. Cytometry Part A 69A:1097-1105

7. Lin X, Flint J, Azaro M, Coradetti T, Kopacka W, Streck D, Wang Z, Dermody J, and Mandecki W. 2007. Microtransponder-based multiplex assay for genotyping cystic fibrosis. Clin Chem 53:1372-1376

8. Robinson E J H. Thomas O. Richardson T O, Sendova-Franks A B, Feinerman O, and Franks N R. 2009. Radio tagging reveals the roles of corpulence, experience and social information in ant decision making. Behav Ecol Sociobiol, 63(5) 627-636

9. MiniScience.com catalog: Test Tube, accessed Mar. 27, 2009]

10. Thomas Scott (transl., 1996), Concise Encyclopedia: Biology. Walter de Gruyter. ISBN 3110106612, 9783110106619. 1287 pages.

11. M. Jeremy Ashcraft, General Manager, Lake Charles Manufacturing (2007). Test Tube Molding Process: A discussion on the molding of plastic test tubes. Lake Charles Manufacturing

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While the foregoing is directed to embodiments of the present invention, other and further embodiments of the invention may be devised without departing from the basic scope thereof, and the scope thereof is determined by the claims that follow. Any claim below that is written as dependent on an independent claim can also be written as dependent on any of the claims under such independent claim, except where logic forecloses such a dependency.

1-4. (canceled)

5. The system of claim 32, wherein the MTP is sealed from the outside with polypropylene or acetal polymer.

6-13. (canceled)

14. The system of claim 32, wherein the means for removing is configured to maintain the plastic test tube at a temperature of −50° C. or less.

15. (canceled)

16. A method of reading an embedded MTP in a system for storing samples of claim 32, comprising:
aligning, with the light source, the embedded MTP in the test tube that has a temperature of −40° C. or less; and
reading the MTP.

17. The method of reading of claim 16, wherein the sealing plastic material is frost coated.

18-26. (canceled)

27. The system of claim 32, wherein the means for removing is configured to maintain the plastic test tube at a temperature of −70° C.

28. The system claim 32, wherein the MTP is sealed from the outside with polypropylene.

29. (canceled)

30. The system for storing samples of claim 32, wherein:
the system comprises an array of 12 or more discrete such light sources configured to read 12 or more said test tubes with embedded MTPs situated in the rack.

31. The system for storing samples of claim 32, wherein:
the box comprises a rack adapted to hold 96 or more such test tubes.

32. A system for storing samples comprising:
a low temperature biorepository;
a box comprising a rack for biorepository test tubes configured with positions to hold 12 or more test tubes, the rack containing at one or more positions a plastic test tube, wherein the plastic test tube has a containment wall, and with an light-triggered MTP embedded within the containment wall at the bottom of the tube near the center of the tube, oriented for reading from below the test tube, wherein the embedded MTP is fully sealed from the outside with plastic;
one or more light sources configured to trigger the MTP;
an automated robot for moving the box from the biorepository to the light source and back,
wherein (a) the robot is configured to serially align the box with the light source or multiple said light sources such that the MTP can be read with the MTP of the plastic test tube if located in any of the test tube positions, or (b) the system further comprises a second robot for serially moving the light source or multiple said light sources relative to the box such that the MTP can be read with the MTP of the plastic test tube if located in any of the test tube positions, or (c) the robot is configured to align the box with an array of said light sources such that the MTP can be read with the MTP of the plastic test tube if located in any of the test tube positions; and
means for removing the box from the biorepository, scanning the test tube positions for MTP triggering, and returning the box to the biorepository while maintaining the plastic test tube at a temperature of −40° C. or less, wherein the light source effective to trigger the MTP in the plastic test tube a said temperature.

33. The system of claim 32, wherein the means for removing is configured to maintain the plastic test tube at a temperature of −60° C.

34. The system for storing samples of claim 32, wherein:
the system comprises an array of 24 or more discrete such light sources configured to read 24 or more said test tubes with embedded MTPs situated in the rack.

35. The system for storing samples of claim 32, wherein:
the system comprises an array of 48 or more discrete such light sources configured to read 48 or more said test tubes with embedded MTPs situated in the rack.

36. The system for storing samples of claim 32, wherein:
the system comprises an array of 96 or more discrete such light sources configured to read 96 or more said test tubes with embedded MTPs situated in the rack.

37. The system for storing samples of claim 32, wherein:
(a) the robot is configured to serially align the box with the light source or multiple said light sources such that the MTP can be read with the MTP of the plastic test tube if located in any of the test tube positions.

38. The system for storing samples of claim 32, wherein:
(b) the system further comprises a second robot for serially moving the light source or multiple said light sources relative to the box such that the MTP can be read with the MTP of the plastic test tube if located in any of the test tube positions.

39. The system for storing samples of claim 32, wherein:
(c) the robot is configured to align the box with an array of said light sources such that the MTP can be read with the MTP of the plastic test tube if located in any of the test tube positions.

40. A method of reading an embedded MTP in a system for storing samples of claim 32, comprising:
aligning, with the light source, the embedded MTP in the test tube that has a temperature of −50° C. or less; and
reading the MTP.

41. A method of reading an embedded MTP in a system for storing samples of claim 32, comprising:
aligning, with the light source, the embedded MTP in the test tube that has a temperature of −60° C. or less; and
reading the MTP.

42. A method of reading an embedded MTP in a system for storing samples of claim 32, comprising:
aligning, with the light source, the embedded MTP in the test tube that has a temperature of −70° C. or less; and
reading the MTP.
